(19) United States
(12) Patent Application Publication
(10) Pub. No.: US 2010/0088172 A1
(43) Pub. Date: Apr. 8, 2010

(54) VALUE ADDED AUCTIONS FOR STORED VALUE ACCOUNTS

(76) Inventor: Marc Rochman, North Miami Beach, FL (US)

Correspondence Address: CAREY, RODRIGUEZ, GREENBERG & PAUL LLP;ATTN: STEVEN M. GREENBERG, ESQ., 950 PENINSULA CORPORATE CIRCLE, SUITE 3020, BOCA RATON, FL, 33487, US

(21) Appl. No.: 12/635,529

(22) Filed: Dec. 10, 2009

Related U.S. Application Data
(63) Continuation-in-part of application No. 12/047,911, filed on Mar. 13, 2008.
Application No. 12/047,911 is a continuation of application No. 11/946,623, filed on Nov. 28, 2007, now abandoned.
Application No. 11/946,623 is a continuation of application No. 12/491,071, filed on Jun. 24, 2009.
(60) Provisional application No. 60/867,517, filed on Nov. 28, 2006.

(51) Int. Cl. G06Q 30/00

(52) U.S. Cl. 705/14.23; 705/14.33; 705/14.39

(57) ABSTRACT

Embodiments of the present invention provide a method, system and computer program product for value added auctions. In an embodiment of the invention, a value added auction method for stored value accounts can be provided. The method can include establishing an online auction and accepting bids from bidders in the online auction. A winning bid and corresponding winning bidder can be determined. Further, a reward can be computed for the winning bidder based upon a nature of participation in the online auction by the winner. Finally, a stored value account can be loaded with a stored value based upon the winning bid and additional stored value can be loaded on a stored value account based upon the computed reward.

### CROSS-REFERENCE TO RELATED APPLICATIONS

This patent application claims the benefit under 35 U.S.C. §120 as a continuation-in-part of presently pending U.S. patent application Ser. No. 12/047,911, entitled SYSTEM AND METHOD FOR ENCOURAGING SALES THROUGH THE PROVISION OF INCENTIVES, filed on Mar. 13, 2008, which is a continuation of now-abandoned U.S. patent application Ser. No. 11/946,623, entitled SYSTEM AND METHOD FOR ENCOURAGING SALES THROUGH THE PROVISION OF INCENTIVES, filed on Nov. 28, 2007 which claims priority from now abandoned U.S. Provisional Patent Application 60/867,517, filed on Nov. 28, 2006 entitled SYSTEM EMPLOYING LINEAR AND NON-LINEAR CASHBACK OR POINT REWARDS IN A NETWORK OF PURCHASERS BUYING ONLINE OR OFFLINE AND AN ASSOCIATED PAYMENT METHOD, the entire teachings of which are incorporated herein by reference, and also presently pending U.S. patent application Ser. No. 12/491,071, filed on Jun. 24, 2009 entitled DEMAND AMALGAMATION FOR ONLINE AUCTIONS, the entire teachings of which are incorporated herein by reference.

### BACKGROUND OF THE INVENTION

1. Field of the Invention

The present invention relates to the field of stored value accounts and stored value cards, and more particularly to the loading of stored value accounts in an on-line auction environment.

2. Description of the Related Art

E-commerce refers to the sale or marketing of goods or services over a computer communications network, for instance the global Internet. Though e-commerce has been part and parcel of computing for many decades, many believe that the development and explosive use of the World Wide Web has catapulted e-commerce as a preferred mode of product and service distribution over and above traditional brick and mortar outlets. In particular, the ubiquity of the e-commerce storefronts has shattered the geographic limitations of traditional in person marketing and sales of goods and services.

E-commerce generally implies direct business to consumer sales of products and services, as well as business-to-business and consumer-to-consumer sales of products and services. The modern e-commerce auction forms a substantial component of on-line sales of goods and services. For many, access to an auction style environment for the sale and purchase of goods and services not only enhances the market by providing an efficient price-setting mechanism for those goods and services, but also on-line shoppers find the on-line auction environment to be both productive and entertaining.

The traditional e-commerce auction generally provides for the offering of one or more products of a particular value to multiple different bidders such that the bidders providing the highest bids are awarded respective ones of the products in exchange for payment of the bids. Other auction models also have been provided, though the most prevalent remains the traditional multi-bidder single unit auction for a single product or service. Notwithstanding, it will be understood that oftentimes consumers are reluctant to bid in an auction for a specific item unless the consumers truly desire to own the item offered. The promise of a discounted price relative to the market value of an item offered for auction acts as a substantial incentive to a potential auction participant. Even still, ultimately the potential auction participant must want to own the item offered for auction.

The auction of stored value accounts addresses the need for the potential auction participant to own an item offered at auction in order to bid upon the auction. In this regard, for some time, gift cards have been available at auction in order to provide flexibility for a winning bidder in purchasing a particular item. Specifically, so long as the gift card won at auction can be redeemed at a retail outlet offering products of interest for a winning bidder, the winning bidder is more likely to bid on the gift card than would be the case if the winning bidder had been compelled to bid directly upon a specific product that may or may not have been of interest to the winning bidder. Notwithstanding, it will be recognized by the skilled artisan that as the bidding for a gift card approaches the value of the gift card, potential bidders lose incentive to continue bidding. Yet, at every auction for a gift card, presuming sufficient participation, the bids provided by bidders for the gift card should converge upon the value of the gift card itself thereby defeating the advantage of an auction from the perspective of the bidders.

### BRIEF SUMMARY OF THE INVENTION

Embodiments of the present invention address deficiencies of the art in respect to the auctioning of gift cards and provide a novel and non-obvious method, system and computer program product for value added auctions. In an embodiment of the invention, a value added auction method for stored value accounts can be provided. The method can include establishing an online auction by an online auction management application executing in memory by a processor of a host server and accepting bids from bidders from over a computer communications network in the online auction. A winning bid and corresponding winning bidder can be determined and a reward can be computed for the winning bidder based upon a nature of participation in the online auction by the winning bidder.

Finally, a stored value of a stored value account can be set based upon the winning bid and additional stored value can be loaded on a stored value account based upon the computed reward. In one aspect of the embodiment, a single stored value account can be loaded with a monetary value that is equivalent to the winning bid. Likewise, in another aspect of the embodiment, additional stored value can be loaded on the single stored value account as a monetary value that is equivalent to the computed reward.

In another embodiment of the invention, an online auction data processing system can be provided. The system can include a host server with processor and memory configured for communicative coupling to different client computing devices over a computer communications network. The system also can include an operating system executing in the memory by the processor of the host server, and a Web server and an application server hosted by the operating system. Further, an online auction management application can be disposed in the application server and can accept bids from bidders for stored value to be loaded onto at least one stored value account. Finally, a value added auction module can be coupled to the online auction management application. The module can include computer program code enabled to load a stored value account with a stored value based upon a winning bid by a winning bidder that has been determined by the online auction management application. The program code of the module further can be enabled to load additional stored value on a stored value account based upon a reward computed for the winning bidder by the online auction management application.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for value added auctions;

FIG. 2 is a schematic illustration of an online auction data processing system configured for conducting value added auctions; and,

FIG. 3 is a flow chart illustrating a process for conducting a value added auction in an online auction data processing system.

### DETAILED DESCRIPTION OF THE INVENTION

Embodiments of the present invention provide a method, system and computer program product for value added auctions. In accordance with an embodiment of the present invention, multiple different bidders can submit bids for a stored value to be loaded into a stored value account. A winning bidder submitting a winning bid can be awarded the loading of the stored value into the stored value account in an amount equivalent to the winning bid. A reward value further can be computed for the winning bidder resulting, by way of example, from a timing of the placement of the winning bid by the winning bidder. Thereafter, the stored value loaded into to the stored value account can be augmented by the reward value. Alternatively, a different stored value account can be loaded with a value equivalent to the reward value and provided to the winning bidder as a reward.

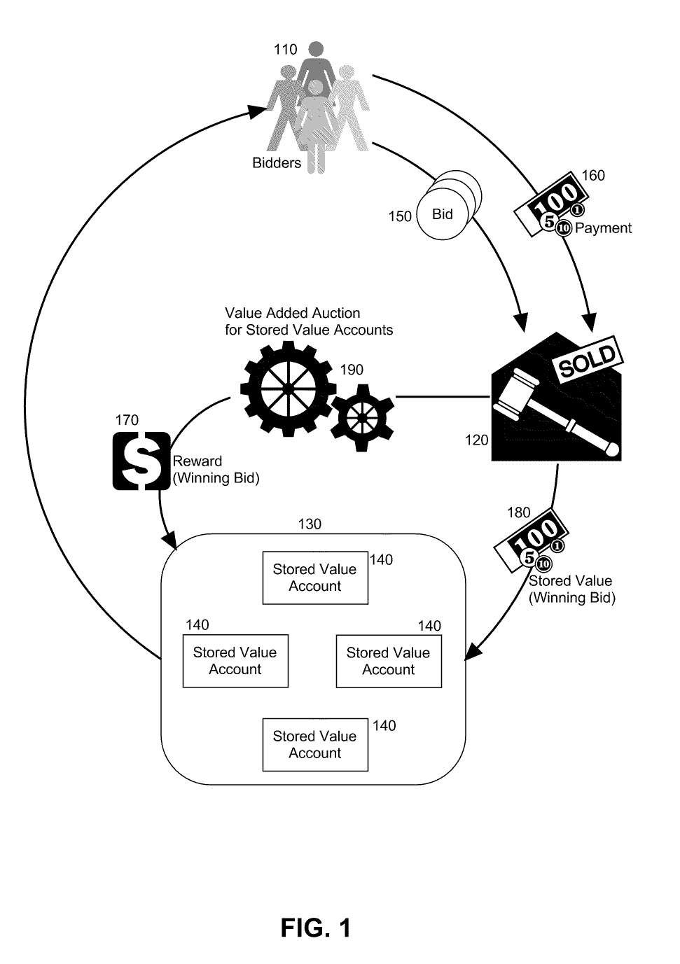

In further illustration, FIG. 1 is a pictorial illustration of a process for value added auctions. As shown in FIG. 1, multiple different bidders 110 can participate in an online auction 120 by providing bids 150 for a stored value to be loaded into a lot 130 of one or more stored value accounts 140. Each of the stored value accounts 140 can be associated with, by way of example, a stored value card, gift certificate, gift card, “e-wallet”, or other such representative article storing an indication of a credit exchangeable for goods or services in the marketplace. A winning one of the bids 150 by a corresponding one of the bidders 110 can be determined and payment 160 corresponding to the winning one of the bids 150 can be accepted from the winning one of the bidders 110. Optionally, multiple winning bids and multiple corresponding bidders can be determined in a single auction (not illustrated). Also optionally, the payment 160 need not be made in cash or credit, but can alternatively be provided in the form of redeemable points such as loyalty points well-known in the art from a corresponding loyalty account established for the winning one of the bidders 110. In any event, an equivalent value 180 for the winning one of the bids 150 can be applied as stored value into the bid upon stored value accounts 140 in the lot 130. In this regard, the equivalent value 180 that can include a monetary value, or a unit value for goods or services can be applied across one or more of the stored value accounts 140.

Importantly, a value added auction process 190 can interoperate with the online auction 120 so as to compute a reward 170 for the winning one of the bidders 110 resulting from the nature of the participation of the winning one of the bidders 110 in the online auction 120. The nature of the participation can include the timing of the winning one of the bid 150 relative to others of the bids 150 provided by others of the bidders 110. For instance, the timing of the winning one of the bids 150 can include a time when the winning one of the bids 150 was placed by the winning one of the bidder 110, the time when the winning one of the bids 150 was received from the winning one of the bidders 110, or any time in between. Alternatively, the nature of the participation can include an outcome from an online game conducted between the bidders 110.

In any event, the value added auction process 190 can apply the computed reward 170 as additional stored value upon the lot 130. By way of example, the computed reward 170 can be applied as additional stored value upon a same one of the stored value accounts 140 as the equivalent value 180. Alternatively, the computed reward 170 can be applied as stored value upon a different one of the stored value accounts 140 than the equivalent value 180. Regardless, ultimately, the lot 130 can be assigned to a winning one of the bidders 110 prevailing in the online auction 120.

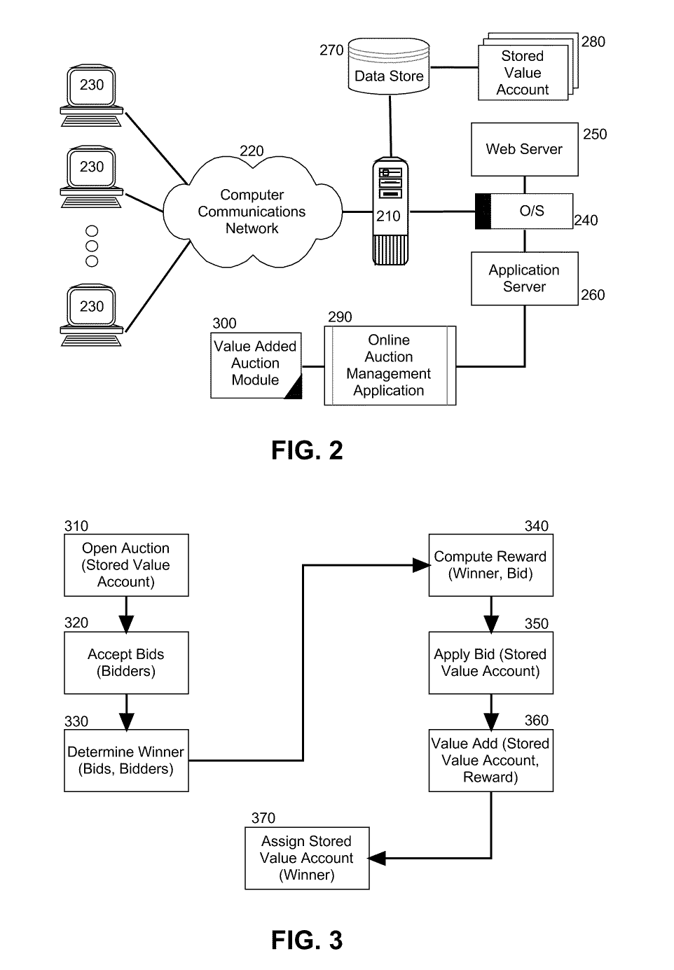

The process described in connection with FIG. 1 can be implemented in an online auction data processing system. In further illustration, FIG. 2 is a schematic illustration of an online auction data processing system configured for conducting value added auctions. The system can include a host server 210 with processor and memory, configured for communicative coupling over computer communications network 220 to different client computing devices 230, such as personal computers, personal digital assistants, Internet enabled cellular telephones, and the like. The host server 210 can include an operating system 240 hosting the execution of both a Web server 250 and an application server 260, both of which are well-known in the art.

The application server 260 in turn can support the operation of an online auction management application 290 composed of a multiplicity of Web components, including different servlets and server pages requisite to providing both a user interface and underlying functionality for managing an online auction over the computer communications network 220 with different bidders through respectively different ones of the client computing devices 230. It is to be understood that while FIG. 2 illustrates the presence of a single host server 210 hosting the execution of the Web server 250 and the application server 260, in a preferred aspect of the embodiment, multiple different host servers can be arranged to host respective application servers supporting different instances of the online auction management application 290 so as to provide high availability for the online auction data processing system.

Of note, a value added auction module 300 can be coupled to the online auction management application 290 and can execute within the application server 260 as well. The value added auction module 300 can include program code which when executed in memory by the processor of the host server 210, can be enabled to apply a winning bid for an auction conducted by the online auction management system 290 as a stored value to one or more stored value accounts 280 disposed in data store 270 coupled to the host server 210. In this regard, the equivalent value of the winning bid in an auction for a stored value account can be applied to a single stored value account, or the equivalent value can be applied across different stored value accounts so that the sum of values applied to the different stored value accounts is the same as the equivalent value. Further, for the purpose of the foregoing description, an equivalent value for a winning bid means either a monetary value amount equivalent to the winning bid, a unit value of different goods or services equivalent to a monetary value of the winning bid, or a point value redeemable for different goods or services equivalent to a monetary value of the winning bid.

In accordance with an embodiment of the present invention, the program code of the value added auction module 300 yet further can be enabled to apply an additional equivalent value to the single stored value account or any one of multiple stored value accounts resulting from the winning bidder winning the online auction. The additional equivalent value can be derived from a reward provided to the winning bidder in consequence of the nature of the participation of the winning bidder in the online auction. The nature of the participation can include the timing of the winning bid placed by the winning bidder relative to other bids provided by other bidders, or even an outcome from an online game conducted between the bidders.

In even yet further illustration of the operation of the value added auction module 300, FIG. 3 is a flow chart illustrating a process for conducting a value added auction in an online auction data processing system. Beginning in block 310, an online auction can be established for multiple different bidders for a lot including one or more stored value accounts. In block 320, bids can be accepted from the different bidders in the form of monetary value bids in the form of a statement of currency, or cash equivalent bids in the form of cash equivalent units such as loyalty points. In block 330, a winner can be determined amongst the bidders based upon the bids received. Further, in block 340 a reward can be computed for the winner based upon the nature of participation of the bidder in the online auction.

In block 350, the winning bid placed by the bidder can be applied as the stored value of the lot. Specifically, to the extent that only a single stored value account is in the lot, than the value of the stored value account can be set to the winning bid. Alternatively, to the extent that different stored value accounts are in the lot, then the value of each stored value account in the lot can be set as a portion of the winning bid so long as the sum total of all values of all stored value accounts in the lot do not exceed the winning bid. Importantly, the value of the lot can be enhanced by applying an additional value to the lot of stored value accounts equivalent to the computed reward in block 360. Finally, in block 370 the lot of stored value accounts can be assigned to the winning bidder.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device). Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

I claim:

1. A value-added auction method for loading stored value accounts, the method comprising:
establishing an online auction by an online auction management application executing in memory by a processor of at least one host server;
accepting bids from bidders over a computer communications network in the online auction;
determining a winning bid and a corresponding winning bidder;
computing a reward for the winning bidder based upon a nature of participation in the online auction by the winning bidder;
first loading stored value on a stored value account setting a stored value of a stored value account based upon the winning bid; and,
second loading stored value on a stored value account adding additional stored value to the stored value account based upon the computed reward.

2. The method of claim 1, wherein the bids are monetary bids.

3. The method of claim 1, wherein the bids are loyalty point bids.

4. The method of claim 1, wherein first loading stored value on a stored value account setting a value of the stored value account based upon the winning bid, comprises first loading a single stored value account with a monetary value that is equivalent to the winning bid.

5. The method of claim 4, wherein second loading stored value on a stored value account adding additional stored value to the stored value account based upon the computed reward, comprises second adding additional stored value toloading additional stored value on the single stored value account as a monetary value that is equivalent to the computed reward.

6. An online auction data processing system comprising:
a host server with processor and memory configured for communicative coupling to a plurality of client computing devices over a computer communications network;
an operating system executing in the memory by the processor of the host server;
a Web server and an application server hosted by the operating system;
an online auction management application disposed in the application server and accepting bids from bidders for stored value to be loaded onto at least one stored value account; and,
a value added auction module coupled to the online auction management application, the module comprising computer program code enabled to first set a stored value of a stored value accountload stored value on a stored value account based upon a winning bid by a winning bidder determined by the online auction management application, and to second load stored value on a stored value account add additional value to the stored value account based upon a reward computed for the winning bidder by the online auction management application.

7. The system of claim 6, wherein the value set for the stored value account the value first loaded on a stored value account based upon the winning bid is a monetary value equivalent to the winning bid.

8. A computer program product comprising a computer usable medium embodying computer usable program code for a value added auction, the computer program product comprising:
computer usable program code for establishing an online auction;
computer usable program code for accepting bids from bidders in the online auction;
computer usable program code for determining a winning bid and a corresponding winning bidder;
computer usable program code for computing a reward for the winning bidder based upon a nature of participation in the online auction by the winning bidder;
computer usable program code for first setting a stored value of a stored value accountloading stored value on a stored value account based upon the winning bid; and,
computer usable program code for second loading stored value on a stored value account adding additional stored value to the stored value account based upon the computed reward.

9. The computer program product of claim 8, wherein the bids are monetary bids.

10. The computer program product of claim 8, wherein the bids are loyalty point bids.

11. The computer program product of claim 8, wherein the computer usable program code for first loading stored value on the stored value account setting the stored value of the stored value account based upon the winning bid, comprises computer usable program code for first loading a single stored value account with a monetary value that is equivalent to the winning bid.

12. The computer program product of claim 11, wherein the computer usable program code for second loading stored value on the stored value account adding additional stored value to the stored value account based upon the computed reward, comprises computer usable program code for second adding additional stored value toloading additional stored value on the single stored value account as a monetary value that is equivalent to the computed reward.
